(19) United States
(12) Patent Application Publication
(10) Pub. No.: US 2025/0352905 A1
(43) Pub. Date: Nov. 20, 2025

(54) AI–ENABLED TELEMATICS FOR ELECTRONIC ENTERTAINMENT, SIMULATION, TRAINING AND REMOTE OPERATIONS SYSTEMS

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 18/665,577

(22) Filed: May 16, 2024

(51) Int. Cl. A63F 13/65; G06N 20/00

(52) U.S. Cl. CPC A63F 13/65; G06N 20/00

(57) ABSTRACT

A system and method AI-enabled telematics and actuation for electronic entertainment, simulation, training, and remote operations systems. The system and method disclosed support neuro symbolic reasoning and generative AI enabled experience generation to allow a user or collection of users to experience a wide range of realistic scenarios where the user can pick and choose an experience that best fits their individual or collective preferences. Additionally, the system and method have wide applications to a variety of environments, including but not limited to, racing, sports, military training, vehicle and aircraft operation, and training simulations. The proposed system and method enable realistic, immersive video game, simulation, training, and remote operations environments which are applicable to a wide range of devices, platforms, and mediums for recreational, commercial, industrial, and security uses.

### CROSS-REFERENCE TO RELATED APPLICATIONS

Priority is claimed in the application data sheet to the following patents or patent applications, each of which is expressly incorporated herein by reference in its entirety:

None.

### BACKGROUND OF THE INVENTION

### Field of the Art

The present invention is in the field of electronic entertainment systems and simulations, particularly systems that utilize or produce telematics data.

### Discussion of the State of the Art

The rise of video game and simulation systems including motion for recreation, betting, immersive sports, training, and even remote piloting or control of real world systems has just begun. Modern computers have become advanced enough to generate lifelike graphics and sounds in video games and many simulations tout nearly one-to-one replicas of vehicles, scenery, and environment experience. The rise of virtual and augmented reality has further pushed video games and simulations to the limit of realism where a user's experience hinges on how seamless the immersion feels to enable superior experiences, monetization opportunities and training applicability. Even small distortions in things like resolution and latency between a user's input and the rendered outcome can completely upset the feeling of realism in both games and simulations or negatively impact training efficacy. To maintain the feeling of realism, or truthiness of experiences, some systems incorporate multiple degrees of freedom motion that allow a user to move in a real space along with a character or avatar in a game or simulation. High-end systems may provide multiple degrees of freedom in which users are moved around within a defined space to replicate movement within the game or simulation. This can be important for experience realization but also for training value, as motion can make routine tasks which are easily performed in a static environment more difficult. These advancements have made their way into a wide variety of industries, including armed forces training, heavy equipment operation and medical procedures,

Generally, systems that incorporate movement utilize a plurality of actuators which change orientation on a fixed platform where a user sits. The changes in orientation are directly linked to a user's input or forces applied on the entity or vehicle being piloted by a user in the software defined environment. For example, in a flight simulator using four actuators, when the user wants to ascend, the front actuators may extend and the rear actuators may compress causing the front of the platform to incline upwards giving the user the sensation of gaining elevation. Motion paired with realistic graphics can create lifelike environments where a user's body experiences sensations on par with what a person feels during similar real life situations. Some systems incorporate vibrations generated by speakers to further enhance the feeling of immersion. To recreate peak realism, as many senses as possible need to be accounted for and vibrations, light, noise, temperature, humidity, and even smell or wind can be procured.

To ensure realism is maintained, every system being used to replicate a sensation needs to operate and receive instructions at near instantaneous speeds to ensure a user is getting feedback in real time. Latency between an input and feedback drastically erodes an immersive experience. This is true for all systems a user interacts with including but not limited to actuators, speakers, controllers, and displays. In many cases, motion (or other sensory actuation) that is out of sync with visual feedback or controls can be worse than none at all.

The issue with current systems is that they only account for a small subset of data when creating realistic simulations or games. Additionally, there are limitations on many of the systems used to replicate motion or other sensory experience elements. Actuators have a limited range of motion which may easily be exhausted depending on the user's inputs and piloted entity position within a game. For example, if a system of actuators is presently configured in a position where a user is tilted to the right as far as the system will allow, any subsequent input to the right will provide no physical feedback because the system is at its limit. This is true for all motion systems with limited range in motion and requires active management to return the user occupied physical simulation controller/chassis to orientations that revive future freedom of movement for subsequent manipulations. A user's experience may be degraded when feedback suddenly stops or clumsily returns towards neutral orientations because of the constraints of the system.

What is needed is a system and method for AI-enabled telematics for electronic entertainment and simulation systems where a plurality of sensory systems including but not limited to speakers, displays, actuators, platforms, vibrators, smell diffusers, and controllers utilize a system enabled by neuro symbolic AI that processes information such as but not limited to telematics data, a past and present state of a simulation or game, and a user's potential inputs and preferences to predict and generate future states and environments of a simulation or game.

### SUMMARY OF THE INVENTION

Accordingly, the inventor has conceived and reduced to practice, a system and method for AI-enabled telematics and actuation for electronic entertainment, simulation, training and remote operations systems. The system and method allow a user to experience a wide range of realistic scenarios where the user can pick and choose an experience that best fits their preferences and configure preferences, to include ongoing learning by the system itself separate from user specified parameters, with a mix of statistics, machine learning, artificial intelligence and generative artificial intelligence. Additionally, the system and method have wide applications to a variety of environments, including but not limited to, racing, sports, military training, vehicle and aircraft operation, and training simulations. The disclosed system and method enable realistic, immersive video game and simulation environments which are applicable to a wide range of video game devices, platforms, and mediums. The system and method generate replicas of real life objects and environments where a user can interact with those objects from a variety of points of view. Users are able to experience lifelike conditions that a professional may experience in a particular environment, which may sometimes be certified or endorsed or tuned by relevant experts or groups of other people or AI agents. Users are also able to train their skills against professionals in a particular environment and see how their skills rank against their peers and professionals or AI agents of known skill. The system and method allow for increased fan interaction from organizations and have applications to gambling where a user can place wages on how their skills rank against their peers and professionals or AI competitors. This enables different pools, rankings or leaderboards and a host of competitions or sports book like challenges with wagers around them. Likewise, generated environments may be turned into challenges where a user attempts to achieve a predetermined goal such as a composite objective function or score from some combination of factors like time, damage, targets, system health, pilot or player health, teamwork scores, relative performance to other players or AI agents (e.g. spread), or comparisons to entire “runs” or segments of similar events, games, races or endeavors being modeled or simulated.

According to a preferred embodiment, a system for AI-enabled telematics and actuation for electronic entertainment, simulation, training and remote operations systems, comprising: a computing device comprising at least a memory and a processor; a plurality of programming instructions stored in the memory and operable on the processor, wherein the first plurality of programming instructions, when operating on the processor, cause the computing device to: collect a plurality of operating data from a plurality of vehicles, operators, and environments wherein operating data may include visual, acoustic, mechanical, and user control data; train a machine learning system using the plurality of operating data on how to produce a plurality of models for vehicles, operators, and environments; produce a plurality of models using the machine learning system and a plurality of generative AI systems; display the plurality of models to a user's electronic video game or simulation system; and generate a simulated user avatar using the plurality of generative AI systems which may enable a user to interact with the plurality of models; is disclosed.

According to another preferred embodiment, a method for AI-enabled telematics and actuation for electronic entertainment, simulation, training and remote operations systems, comprising the steps of: collecting a plurality of operating data from a plurality of vehicles, operators, and environments wherein operating data may include visual, acoustic, mechanical, and user control data; training a machine learning system using the plurality of operating data on how to produce a plurality of models for vehicles, operators, and environments; producing a plurality of models using the machine learning system and a plurality of generative AI systems; displaying the plurality of models to a user's electronic video game or simulation system; and generating a simulated user avatar using the plurality of generative AI systems which may enable a user to interact with the plurality of models, is disclosed.

According to an aspect of an embodiment, the operating data further comprises the past and current positions of a plurality of actuators operable paired with the user's electronic video game or simulation system.

According to an aspect of an embodiment, the machine learning system is further trained using the past and current positions of the plurality of actuators, wherein the machine learning system may establish a preferred actuator position where actuators may gradually return after throughout a plurality of user inputs.

According to an aspect of an embodiment, the simulated user avatar may take the place of a selected modeled operator in a selected modeled vehicle while the selected modeled vehicle traverses through a selected modeled environment.

According to an aspect of an embodiment, a user may control the selected modeled vehicle and interact with the plurality of modeled vehicles, operators, and environments which the machine learning system or plurality of generative AI systems may update depending on the plurality of user inputs.

According to an aspect of an embodiment, the user's ability to control the selected modeled vehicle is restricted depending the difference in a first position where the selected modeled operator is controlling the selected modeled vehicle and a second position where the plurality of user inputs is controlling the selected modeled vehicle.

### BRIEF DESCRIPTION OF THE DRAWING FIGURES

FIG. 1 is a block diagram illustrating an exemplary system architecture for AI-enabled telematics and actuation for electronic entertainment, simulation, training and remote operations systems.

FIG. 2 is a block diagram illustrating an exemplary architecture for a subsystem of the system for AI-enabled telematics and actuation for electronic entertainment, simulation, training and remote operations systems, a Machine Learning system.

FIG. 3 is a block diagram illustrating an exemplary architecture for a component of an AI-enabled telematics and actuation for electronic entertainment, simulation, training and remote operations systems, a Generative AI system.

FIG. 4 is a diagram showing an embodiment of one aspect of the system and method for AI-enabled telematics and actuation for electronic entertainment, simulation, training and remote operations systems, specifically, using a machine learning system to update actuator position.

FIG. 5 is a diagram showing an embodiment of one aspect of the system and method for AI-enabled telematics and actuation for electronic entertainment, simulation, training and remote operations systems, specifically, generating racing environments from telematics data.

FIG. 6 is a block diagram illustrating an exemplary architecture for a component of a system for AI-enabled telematics and actuation for electronic entertainment, simulation, training and remote operations systems, specifically, a user device.

FIG. 7 is a flow diagram illustrating an exemplary method for ranking and comparing users, according to an embodiment.

FIG. 8 is a flow diagram illustrating an exemplary method for generating game states from a plurality of collected data.

FIG. 9 is a flow diagram illustrating an exemplary method for generating sound and

broadcasting sound to a user's device.

FIG. 10 is a flow diagram illustrating an exemplary method for generating visuals and displaying visuals to a user's device.

FIG. 11 is a flow diagram illustrating an exemplary method for generating haptic feedback and incorporating the feedback into a user's device.

FIG. 12 is a flow diagram illustrating an exemplary method for creating a user simulation profile.

FIG. 13 is a flow diagram illustrating an exemplary method for a creating a possible game state; replay.

FIG. 14 is a flow diagram illustrating an exemplary method for a creating a possible game state; free play.

FIG. 15 is a flow diagram illustrating an exemplary method for a creating a possible game state; training wheels.

FIG. 16 illustrates an exemplary computing environment on which an embodiment described herein may be implemented, in full or in part.

### DETAILED DESCRIPTION OF THE INVENTION

The inventor has conceived, and reduced to practice, a system and method for AI-enabled telematics and actuation for electronic entertainment, simulation, training and remote operations systems.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

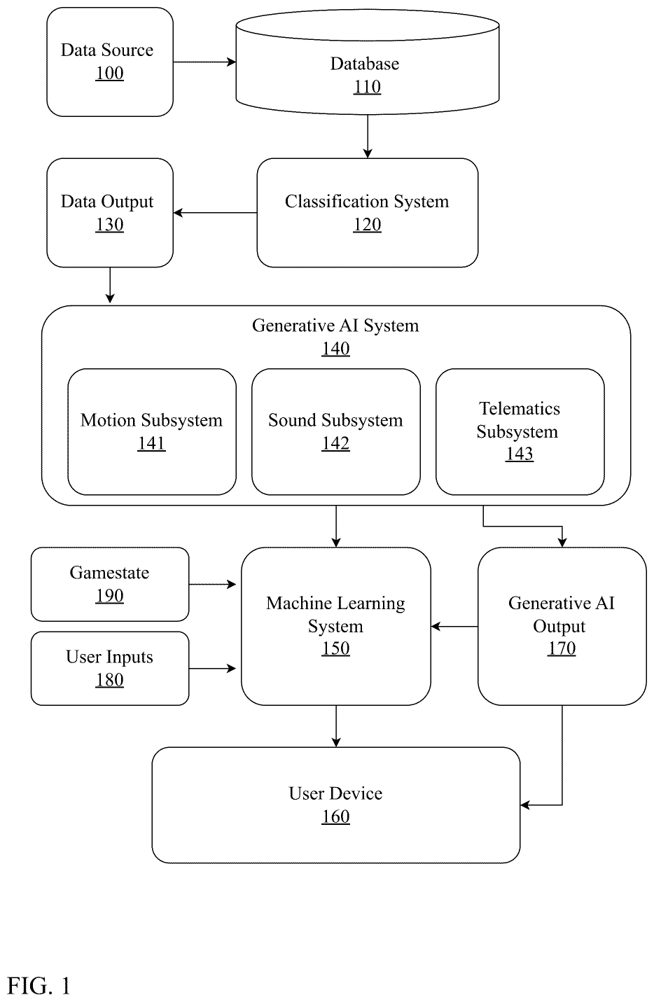

FIG. 1 is a block diagram illustrating an exemplary system architecture for AI-enabled telematics and actuation for electronic entertainment, simulation, training and remote operations systems. In one embodiment, a system for AI-enabled telematics for electronic entertainment and simulation systems comprises a plurality of data sources 100, a plurality of databases 110, a data classification system 120, a data output 130, a generative AI system 140 comprising a plurality of generative AI subsystems, a plurality of generative AI outputs 170, a machine learning system 150, game state data 190, user input data 180, and a user device 160.

The system may receive a plurality of data from a plurality of data sources 100. Data sources may include but are not limited to cameras, microphones, speedometers, accelerometers, or global positioning systems (GPS). Data sources will vary depending on the desired video game or simulation environment. For example, a game or simulation about flying airplanes may include additional data sources for altitude and lift. All data collected by the system may be stored in a plurality of databases 110 which may include but are not limited to cloud based storage systems. Data is classed by a classification system 120 where datasets are formed based on where data was collected from. For example, all data pertaining to speed collected from an accelerometer may be classed together. Likewise, any data pertaining to altitude will be in its own class. Classed data is then output from the classification system 120 as data output 130. Data output 130 may be passed through a generative AI system 140 which comprises a plurality of generative AI subsystems. In one embodiment, the generative AI system 140 may further comprise a motion subsystem 141, a sound subsystem 142, and a telematics subsystem 143. The generative AI system may further comprise a plurality of additional subsystems for any and all classed data outputs 130. Which subsystems are needed will vary depending on the video game or simulation environment being created.

The generative AI system 140 will take in classed data outputs 130 and pass each data set to a corresponding generative AI subsystem. Each subsystem will generate a generative AI output 170 corresponding to each classed data output 130 passed through the generative AI system 140. For example, if sound data was passed through a sound subsystem 142, the generative AI output 170 may consist of newly generated sound data pertaining to a desired video game or simulation environment. In one embodiment, the classed data output 130 may include sound data from a Formula One (F1) race. The sound data may include sound from inside a vehicle, from surrounding vehicles, and from the nearby crowd. The generative AI system 140 may receive the sound data and relay the data to a specific sound subsystem 142. The sound subsystem 142 may then process the data and generate new sound data based on a desired output. For example, the sound subsystem 142 may process the input sound data and generate a sound profile for a specific vehicle at an F1 race. The profile may include what it sounds like from inside the vehicle and the crowd outside. This sound profile may then be either further processed by a machine learning system 150 or broadcast directly to a user device 160.

The machine learning system 150 may take inputs from a plurality of sources including but not limited to the generative AI system 140, a generative AI subsystem, a game or simulation state through game state data 190, and directly from a user through user inputs 180. Game state data 190 may include but is not limited to map data, telemetry, vehicle conditions, player decisions, acceleration, velocity, vectors, physics engine data, xyzzy positions, and pitch and yaw positional data. User input data 180 includes but is not limited to historical input data for a particular user, present input data, or user preferred settings. The machine learning system 140 may compile game state data 190 and user input data 180 to better constrain the range of future game states including but not limited to possible motion, vibration, smells, and sounds that a user may be subjected to. The machine learning system 140 is able to control the natural momentum of the game by predicting and generating an optimal future game state.

In one embodiment, the machine learning system 150 may process a plurality of data about a professional in a particular field. For example, the machine learning system 150 may process a plurality of data for Boston Red Sox former pitcher Pedro Martinez. The machine learning system may create a professional profile using a plurality of algorithms where the professional profile is a recreation of how that professional would perform. In the context of Pedro Martinez, the machine learning system 150 may create a professional profile which captures traits such as but not limited to Martinez's stance, his form, his power, his accuracy, and other data points to recreate an experience for a user where they are pitted against a virtual professional such as Pedro Martinez. The generative AI system 140 may separately collect data about a particular professional. In the context of Pedro Martinez, the generative AI system 140 may collect and processes data such as but not limited to appearance, form, figure, power, accuracy, skills, and other activity related statistics. The generative AI system may then create an environment which replicates an environment where a particular professional may operate. For example, in the context of Pedro Martinez, the generative AI system 140 may create a realistic environment which replicates Fenway Park where Martinez played many of his games. A user may then be placed in the created realistic environment where they may interact with it using a user device. The machine learning system 150 may incorporate the professional profile into the realistic environment where the user can interact with a recreation of a professional in an environment where they would have performed.

Additionally, the machine learning system 150 may collect and process user input data based on how they interact in the generated realistic environment. The machine learning system 150 may process the user input data into a user profile. The user profile may then be compared against a plurality of other user profiles or a plurality of professional profiles where the machine learning system 150 may determine how close a user is to a particular professional. This allows the system to rank users amongst themselves and display to users how they compare to professionals a particular task. Additionally, this allows talent agencies to easily view users who perform well in a particular environment and who closely compare to professionals in that environment. Similarly, this embodiment may lead to fun activities where users complete in challenges based on populated professional profiles and generated environments. For example, one challenge may be to hit a pitch from former Boston Red Sox pitcher Pedro Martinez. This allows organizations to grow fan bases, create promotional challenges, or generate challenges where users pay money to pit their skills against professionals or groups of other users.

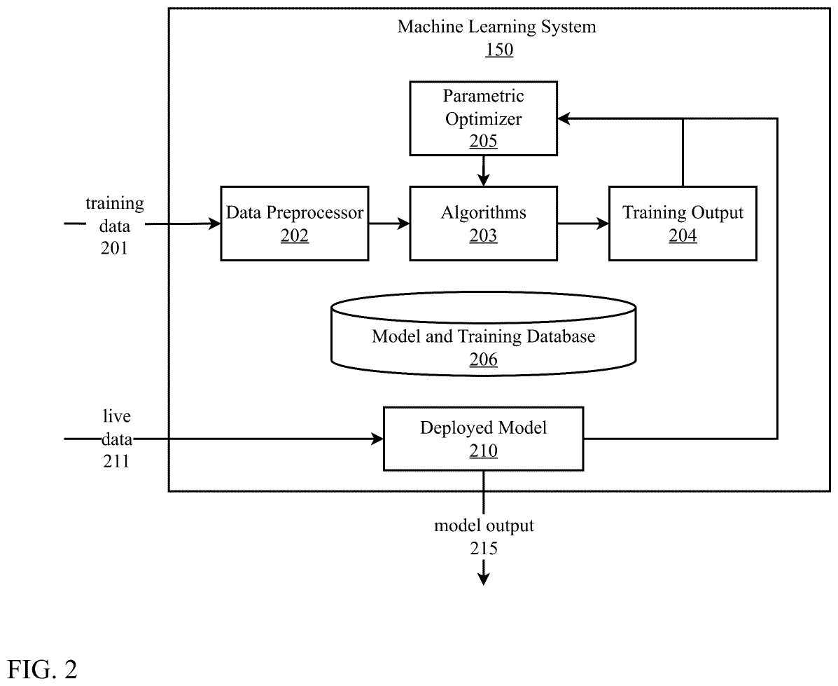

FIG. 2 is a block diagram illustrating an exemplary architecture for a subsystem of the system for AI-enabled telematics and actuation for electronic entertainment, simulation, training and remote operations systems, a Machine Learning system 150. According to the embodiment, machine learning engine may comprise a model training stage comprising a data preprocessor 202, one or more machine and/or deep learning algorithms 203, training output 204, and a parametric optimizer 205, and a model deployment stage comprising a deployed and fully trained model 210 configured to perform tasks described herein such as transcription, summarization, agent coaching, and agent guidance.

At the model training stage, a plurality of training data 201 may be received at machine learning engine 200. In some embodiments, the plurality of training data may be obtained from one or more databases 110 and/or directly from various sources such as but not limited to a videogame or simulation game state 190 or user inputs 180. Data preprocessor 202 may receive the input data (e.g., videogame or simulation game state data) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 202 may also be configured to create a training dataset, a validation dataset, and a test set from the plurality of input data 201. For example, a training dataset may comprise 80% of the preprocessed input data, the validation set 10%, and the test dataset may comprise the remaining 10% of the data. The preprocessed training dataset may be fed as input into one or more machine and/or deep learning algorithms 203 to train a predictive model for object monitoring and detection.

Machine learning engine 150 may be fine-tuned to ensure each model performed in accordance with a desired outcome. Fine-tuning involves adjusting the model's parameters to make it perform better on specific tasks or data. In this case, the goal is to improve the model's performance on video game or simulation data. The fine-tuned models are expected to provide improved accuracy and quality when processing video game or simulation data, which can be crucial for applications like predicting and generating future game states. The refined models can be optimized for real-time processing, meaning they can quickly analyze and understand game states and user inputs as they happen. Additionally, by using the smaller, fine-tuned models instead of a larger model for routine tasks, the machine learning system 150 reduces computational costs associated with AI processing.

During model training, training output 204 is produced and used to measure the accuracy and usefulness of the predictive outputs. During this process a parametric optimizer 205 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation units in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by machine learning engine 150 to evaluate a model's performance. Metrics may include, but are not limited to latency between a user input and a generated game state, quality of generated game states, and the realism of generated game states.

The test dataset can be used to test the accuracy of the model outputs. If the training model is making predictions that satisfy a certain criterion then it can be moved to the model deployment stage as a fully trained and deployed model 210 in a production environment making predictions based on live input data 211 (e.g., video game or simulation game state data). Further, model predictions made by a deployed model can be used as feedback and applied to model training in the training stage, wherein the model is continuously learning over time using both training data and live data and predictions.

A model and training database 206 is present and configured to store training/test datasets and developed models. Database 206 may also store previous versions of models. Database 206 may be a part of database(s) 110.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 203 may comprise a deep learning algorithm such as neural networks (e.g., recurrent, convolutional, long short-term memory networks, etc.).

In some implementations, ML engine 150 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 110.

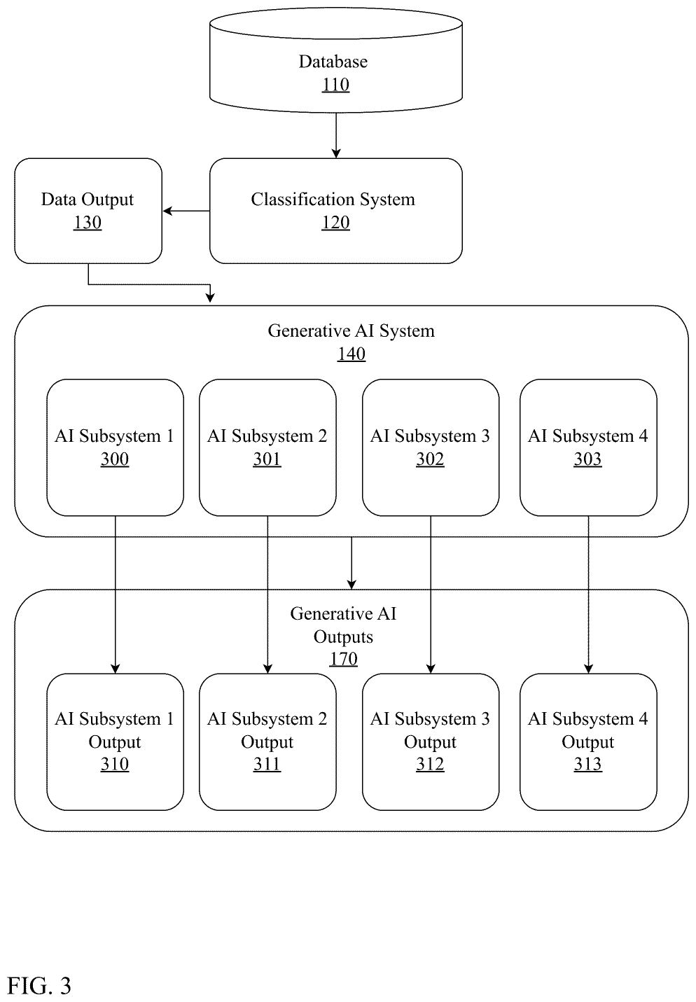

FIG. 3 is a block diagram illustrating an exemplary architecture for a component of for AI-enabled telematics and actuation for electronic entertainment, simulation, training and remote operations systems, a Generative AI system. The generative AI system 140 may further comprise a plurality of AI subsystems. Each AI subsystem receives and processes a particular set of data from the classification system 120 in the form of a data output 130. An AI subsystem's input may vary depending on the particular environment to be generated. Each AI subsystem will generate a corresponding AI subsystem output. For example, the generative AI system 140 may receive sound data from the classification system 120. Sound data may be allocated to AI subsystem 1 300. The data will be processed and a generative AI output 170 will be created. The generative AI output 170 may be further broken down into a plurality of subsystem outputs. For example, sound data processed by AI subsystem 1 300 may be output by the AI subsystem 1 output 310. Any plurality of AI subsystems will generate that same plurality of corresponding AI subsystem outputs.

In one embodiment, a user may be playing an F1 game or training in an F1 simulator. To simulate a particular race, the generative AI system 140 will receive a plurality of data from the classification system 120 such as but not limited to course shape, weather conditions, and acceleration, deceleration, velocity, impulse, traction, and temperature data for a plurality of vehicles. The generative AI system 140 may generate any number of vehicles depending on the desired environment. Additionally, using professional profiles generated by the machine learning system 150, the generative AI system 140 may create avatars for any number of professionals for a given environment. This means the generative AI system 140 can receive data about a particular F1 vehicle, for example, the RedBull car, and generate a replicate of that vehicle with accurate telematics on a replicated F1 track. Likewise, the generative AI system 140 may generate avatars and race styles for particular professional racers. The ability to replicate, or not replicate, a variety of environmental elements allows a user to engage a game or simulation in new ways. For example, a user may want to race against Max Verstappen in the same car so the user can test their abilities against a professional. A user may “ride along” with a virtually generated Charles LeClerc where the user can experience the sounds, forces, speeds, and other telematics associated with LeClerc during a particular race. Additionally, any professional profile may be generated in connection with any particular vehicle. For example, a user can experience whether LeClerc would have beaten Verstappen in a given race on a given track if LeClerc was operating a different vehicle with superior performance. These types of generated experiences allows for unlimited combinations for both gaming and simulation environments. The applications may be expanded to any environment where a plurality of data may be gathered.

Another example may be generating realistic environments for military training for flying an F-22. The generative AI system 140 may receive a plurality of data related to the F-22 and a plurality of other aircraft. The generative AI system 140 may then replace an environment where a user can experience a realistic F-22 environment. The generative AI system 140 replicate an environment including but not limited to all necessary components of an F-22, the movement of an F-22 through actuators, the sound of being in an F-22, and other forms of telematics. Generating more realistic training environments improves the quality of training because it subjects user to situations more on par with what would be encountered in real life.

In some embodiments, the disclosed system may be expanded to apply to a plurality of industry jobs such as armed forces training, space crew training, a medical device operation. In addition to rendering and simulating cars and airplanes, the system may collect data from vehicles such as but not limited to boats, space systems, medical devices, and robots. Additionally, the system may be configured to allow remote piloting of simulated or rendered vehicles, devices, or robots. In embodiments with remote piloting, the generative AI system 170 may render a virtual or simulated environment which includes a vehicle, device, or robot which may be remotely operated in real time. Examples of this capability include but are not limited to, operating a robot in an industrial facility which is too dangerous for in person operation. The dangerous environment may be simulated through the generative AI system 170 to replicate the conditions without the threat of any imminent danger.

In another embodiment, the system may be configured to allow groups of spectators to remotely view a user operating within a virtual or rendered space. For example, a user is operating a surgical device in a virtual environment and groups or graders are spectating as the user conducts a virtual procedure. In another example, a user is operating a virtual F1 vehicle and crowds of people may spectate as the user maneuvers through the virtual environment.

### DETAILED DESCRIPTION OF EXEMPLARY ASPECTS

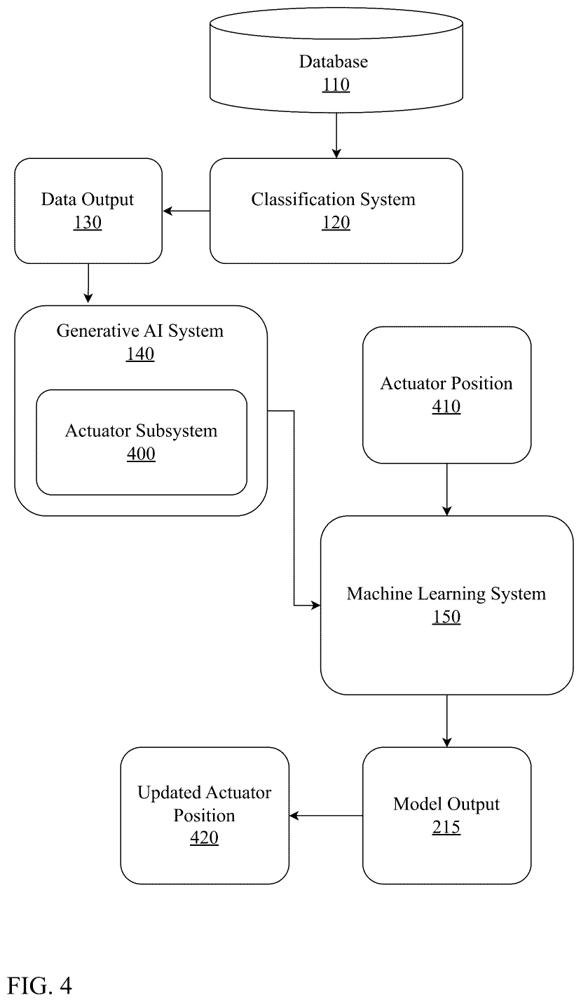

FIG. 4 is a diagram showing an embodiment of one aspect of the system and method for AI-enabled telematics and actuation for electronic entertainment, simulation, training and remote operations systems, specifically, using a machine learning system to update actuator position. Many gaming and simulation systems utilize a plurality of actuators to translate virtual movement into real movement for a user. In one embodiment, the generative AI system 140 may have an actuator subsystem 400 which receives a plurality of telematics data pertaining to a particular environment. For example, if the environment being replicated is a F1 race, a vehicle in the race will only be able to move along a constrained track. Walls or barriers may prevent a driver from veering too far off course. Additionally, vehicles have predetermined turn radii which limit the range of motion for any given vehicle. Data about the course and each vehicle may be processed by an actuator subsystem 400 to generate an actuator profile which determines the given possible range of motion for an object within a particular environment. The actuator profile may then be passed through a machine learning system 150 which may also receive data based on the current position of each actuator. The machine learning system may synthesize the actuator profile and the current position of each actuator and generate a model output 215 which controls subsequent updated actuator positions 420. Additionally, the machine learning system 150 may generate a resting actuator position which is a default position the actuators return to when not being engaged. In active motion sequences, a series of resting position and orientation sets may be generated to maximize future range of motion within a finite time horizon to improve realism or difficulty or other elements in a configured objective function—i.e. the default position set of the motion platform (be it an individual seat or an entire motion platform or cockpit) need not be the true system neutral. Movement back to the resting actuator position may be gradual and over time so the user's experience is not interrupted by unexpected motion. Slow and gradual motion allows the user to continue making movements in a particular direction even when an actuator's range of motion has been fully exhausted. The motion profile expectations and the neutral position configurations as projected over a finite time horizon looking both forward and backward from current time (real or simulated) can be evaluated for acceleration, velocity, impulse, etc. . . . to include optional simulation of impact on occupants for health, safety, or training realism concerns which may also be stored in a database or logged for audit, records, and ongoing learning for experience or safety improvement. This can also enable A/B style testing to gain user feedback and run parametric studies on different motion parameters, actuation parameters, telematics ingestion parameters, etc. . . . to maximize user engagement or performance.

In another embodiment, the machine learning system 150 may process past and present data and make predictions about where a user may move in the future. Past and present data may include but is not limited to, map data, telemetry, vehicle condition, player decisions, acceleration, velocity, vectors, physics engines, xyzzy positions, and other positional information. This can be done in ML/AI based approaches or statistical approaches but it can also include blends of connectionist and symbolic AI systems. E.g., ML/AI tools can be used to approximate inputs for problems that enable formulation into traditional finite element analysis, fluid structure interactions, thermodynamics, physics or other modeling software systems that use traditional engineering and science and mathematics at times. This can enable better blends of empirically trained models from real world and simulated motion and telematics data with engineering design type information from platforms-which can enable more efficient feedback and focus group type interactions in all kinds of platform design problems ranging from automobiles to planes to helicopters to motorcycles. The machine learning system 150 processes past and present game data to generate a predicted actuation profile. This predicted actuation profiles may vary depending on the environment being generated. For example, a person is at rest and about to take a step. A probability exists that the person might move straight ahead, left or right, or backwards. Based on the probabilities of each motion the machine learning system 150 or the simulation system may predict the most likely subsequent motion or motion sequence. The context can be changed to apply to NASCAR racing where a driver generally moves forward and to the left. By breaking down motion into a series of probabilistic events, the machine learning engine 150 can reduce how drastic it feels to return to the actuator's resting position for a given time period, whether it happens to be system neutral or an alternative calculated temporary neutral to maximize realism. In highly dynamic environments where forecasting indicates a high degree of uncertainty (e.g. dogfighting jets) the objective function for determining neutral of a given time point can provide additional value to increase the focus on future freedom of action across a broader range of potential future scenarios, effectively the opposite of the NASCAR circular track case.

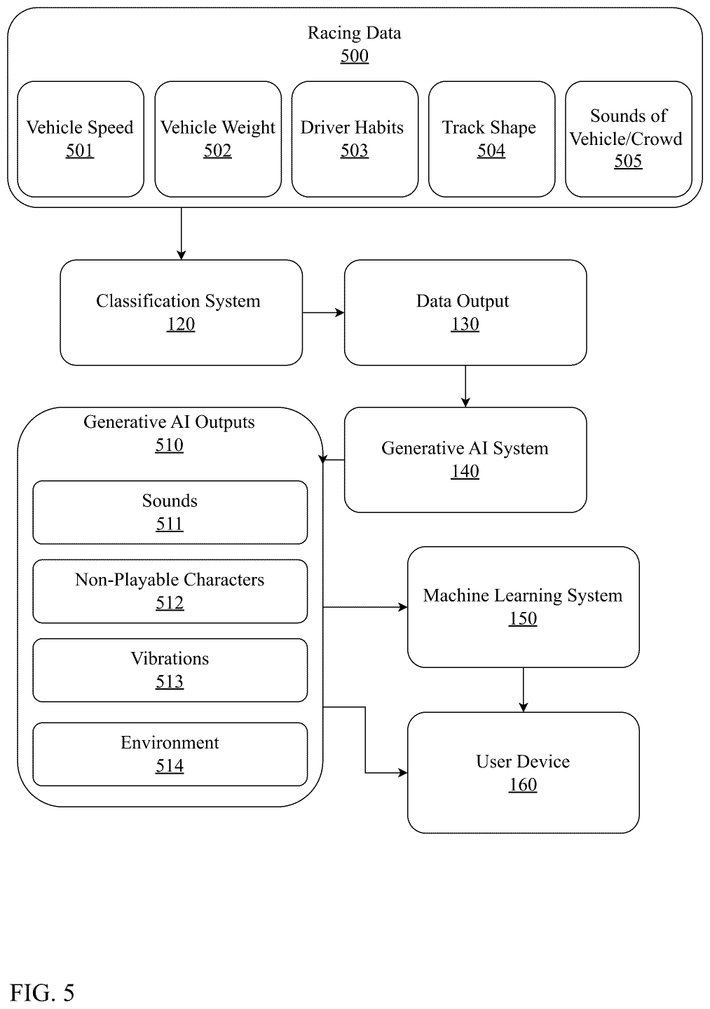

FIG. 5 is a diagram showing an embodiment of one aspect of the system and method for AI-enabled telematics and actuation for electronic entertainment, simulation, training and remote operations systems, specifically, generating racing environments from telematics data. In one embodiment, the classification system 120 may receive racing data 500 from a plurality of data sources. Racing data 500 may include, but is not limited to vehicle speed 501, vehicle weight 502, driver habits 503, track shape 504, and sounds of the vehicle or crowd 505. The classification system 120 may send a data output 130 to a generative AI system 140. The generative AI system 140 may output a plurality of generative AI outputs 510 pertaining to the corresponding data outputs 130. Some examples of generative AI outputs 510 may include but are not limited to sounds 511, non-playable characters 512, vibrations 513, and a plurality of environments 514. The generative AI outputs 510 may then be passed through a machine learning system 150 which will process the generative AI outputs 510 to predict and generate new environments based on the data. Additionally, generative AI outputs 510 may be sent directly to a user device 160.

In one embodiment, the generative AI system 140 may receive GPS data as an input where the system may generate tracks and courses which resemble tracks and courses in real life. For example, using GPS data, cameras, drone footage, and other image based data sources the generative AI system 140 may recreate a realistic virtual rendering of the Monaco F1 racetrack. In another embodiment, the generative AI system 140 may turn any starting point and ending point into a track by generating a traversable terrain between two points. For example, a user may want to drive a virtual racecar along a track which connects the German Autobahn with the peak of Mount Everest. The generative AI system 140 may process image and GPS data between those two points and render a virtual track which is comparable to traversing those two points in reality.

In another embodiment, the generative AI system 140 may process data about professionals in a particular area. For example, the generative AI system 140 may process data about popular F1 drivers such as but not limited to, driving habits, skill level, and vehicle information. The machine learning system 150 may access generative AI system outputs 510 to create professional profiles using data outputs pertaining to professionals at a given task. For example, the machine learning system 150 may create a professional profile for Charles Leclerc, a professional F1 driver. The machine learning system 150 may then populate a virtual Charles LeClerc based on his professional profile into a generated vehicle where the virtual Charles Leclerc drives the vehicle similarly to how he would drive in real life. This function may be translated into a variety of features. One feature is where a user wants to ride with a professional racer. The user may experience a race from inside of a vehicle while a virtual professional driver operates the vehicle. Additionally, a user may elect to take control of the vehicle at any point in the game or simulation. The generative AI system 140 and the machine learning system 150 may continually generate a continuous track or simulation based on where the virtual professional driver left off. This allows users to jump in at various points of a race or simulation depending on user preference.

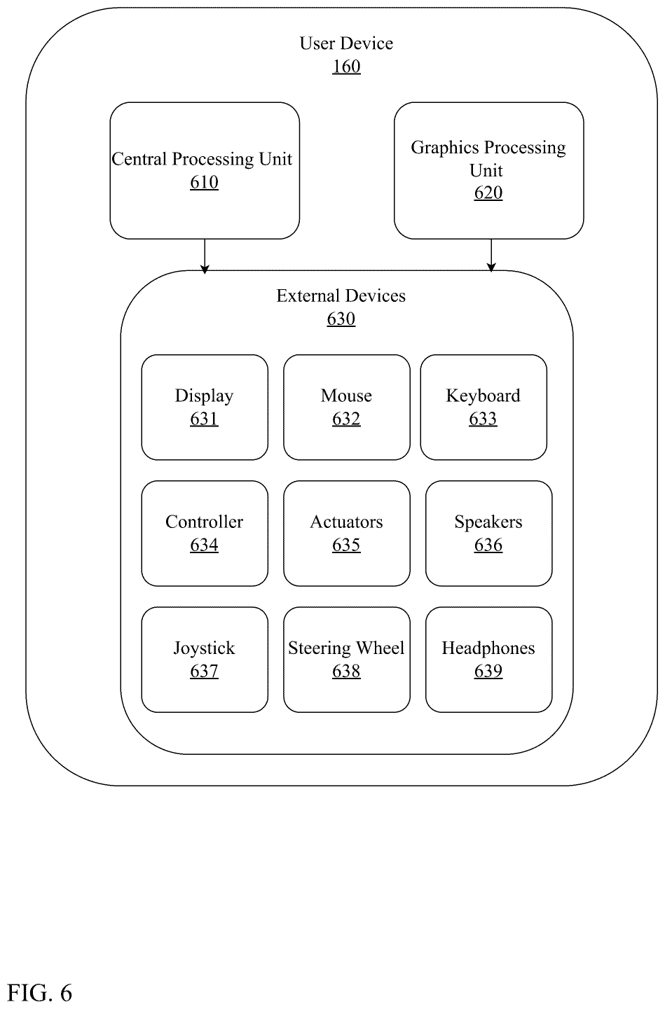

FIG. 6 is a block diagram illustrating an exemplary architecture for a component of a system for AI-enabled telematics for electronic entertainment and simulation systems, specifically, a user device. In general, the user device 160 serves as an intermediary between the user and the virtual environment. Generated environments may be displayed to a user device 160 where the user may then interact with the environment. In one embodiment, a user device 160 may include electronic devices with a central processing unit 610 (CPU) and a graphics processing unit 620 (GPU). A large variety of external devices 630 may be operably paired to either the CPU 610 or the GPU 620 to allow a user to interact or experience a virtual environment in a variety of ways. Some external devices 630 may include, but are not limited to, a display 631, a mouse 632, a keyboard 633, a controller 634, a plurality of actuators 635 which may or may not be positioned on a platform, a plurality of speakers 636, a joystick controller 637, a steering wheel 638, or headphones 639. The external devices 630 may vary depending on the kind of device being used by a user. For example, if the used is engaging with a virtual environment with an Xbox, the external devices may only consist of a display 631 and a controller 634. The quantity and quality of external devices may vary depending on the particular video game or simulation environment. For example, a racing simulation may include a display 631, a steering wheel 638, brakes, a gas pedal, and a clutch, while a flight simulator may include a display 631 and a joystick 637.

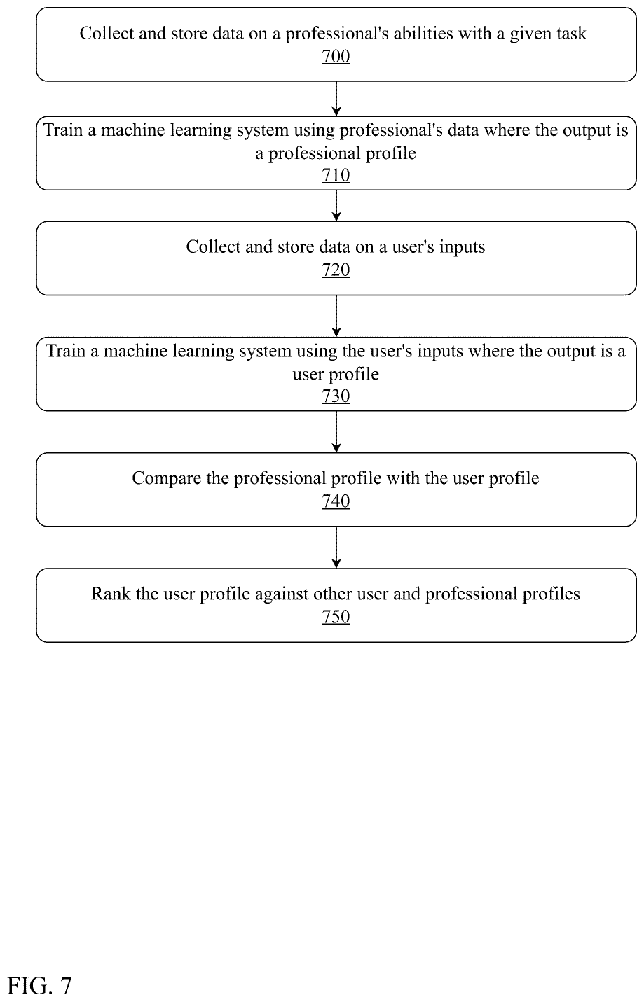

FIG. 7 is a flow diagram illustrating an exemplary method for ranking and comparing users, according to an embodiment. In a first step 700, data is collected and stored on a professional's abilities with a given task. In a step 710, a machine learning system is trained using a professional's data where the output is a professional profile. In a step 720, data about a user's inputs and preferences is collected and stored. In a step 730, the machine learning system is trained using the user's inputs and preferences where the output is a user profile. In a step 740, the professional profile is compared against the user profile. Additionally, user profiles may be compared against other user profiles or groups of profiles. In a step 750, a plurality of user profiles and a plurality of professional profiles are ranked based on similarity regarding a particular set of data or a plurality of datasets. For example, the plurality of professional profiles may comprise a plurality of Major League Baseball (MLB) players. The plurality of user profiles may be ranked against the MLB player's professional profiles based on a statistics such as but not limited to batting average, number of home runs, or the number of total hits.

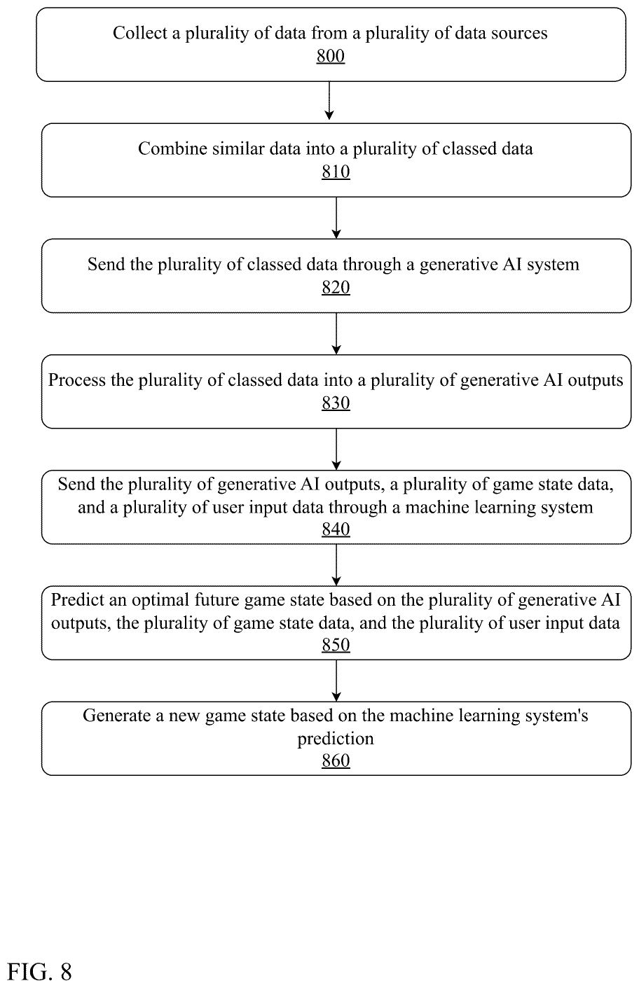

FIG. 8 is a flow diagram illustrating an exemplary method for generating game states from a plurality of collected data. In a first step 800, collect a plurality of data from a plurality of data sources. In step 810, combine similar data into a plurality of classed data. In step 820, send the plurality of classed data through a generative AI system. In a step 830, process the plurality of classed data into a plurality of generative AI outputs. In a step 840, send the plurality of the generative AI outputs, a plurality of game state data, and a plurality of user input data through a machine learning system. In step 850, predict an optimal future game state based on the plurality of generative AI outputs, the plurality of game state data, and the plurality of user input data. In a step 860, generate a new game state based on the machine learning system's prediction.

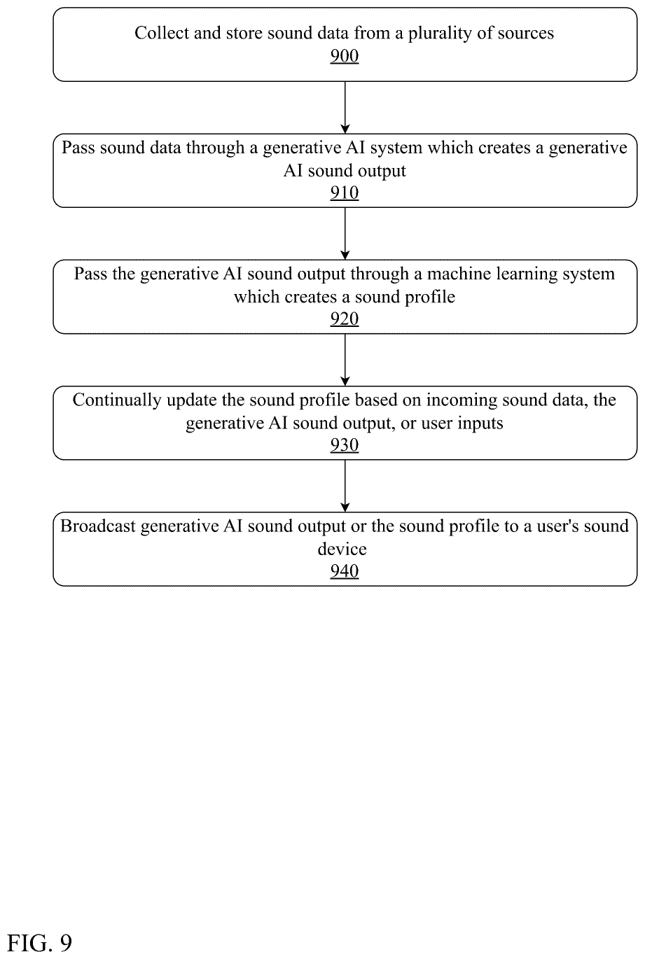

FIG. 9 is a flow diagram illustrating an exemplary method for generating sound and broadcasting sound to a user's device. In a first step 900, collect and store sound data from a plurality of sources. The plurality of sources may vary depending on the environment to be rendered. For example, in a racing game or simulation sound sources may include but is not limited to vehicle engines, brakes, crowd noises, or tire sounds. Sound data may be stored in a plurality of databases, or passed directly to a generative AI system. In step 910, pass the sound data through a generative AI system which creates a generative AI sound output. The generative AI sound system may take in the plurality of sound data and generate additional sounds which further improve the realism of a generated environment. For example, the generative AI system may take in sound data pertaining to the sounds of a car on a racetrack. The generative AI system may then generate additional sounds for any number of cars. If the generative AI system receives a plurality of sound data for an engine at 7000 RPM and 3000 RPM, the generative AI system may generate sounds for all RPM in-between which may be incorporated into vehicles in a virtual environment.

In step 920, pass the generative AI sound output through a machine learning system which creates a sound profile. The sound profile may include but is not limited to all the sounds for a plurality of elements in a generated environment, background sound in a generated environment, and sounds based on user inputs. For example, in a racing environment, the sound profile may include all the cars on the track and the sounds associated with their corresponding actions, the sounds of the crowd, the sounds of any environmental factors like rain or wind, and the sounds associated with any actions a user takes while in the generated environment. If the user presses on the gas in the environment, a sound of the vehicle accelerating may be generated in the sound profile. In step 930, continually update the sound profile based on incoming sound data, the generative AI sound data, or user inputs. In step 940, broadcast generative AI sound data outputs or the sound to a user's sound device. The user's sound device may vary depending on user preferences, for example, one user may prefer a surround sound system while others may use over the ear headphones. The method used for broadcasting may also vary depending on the user's preferred sound device.

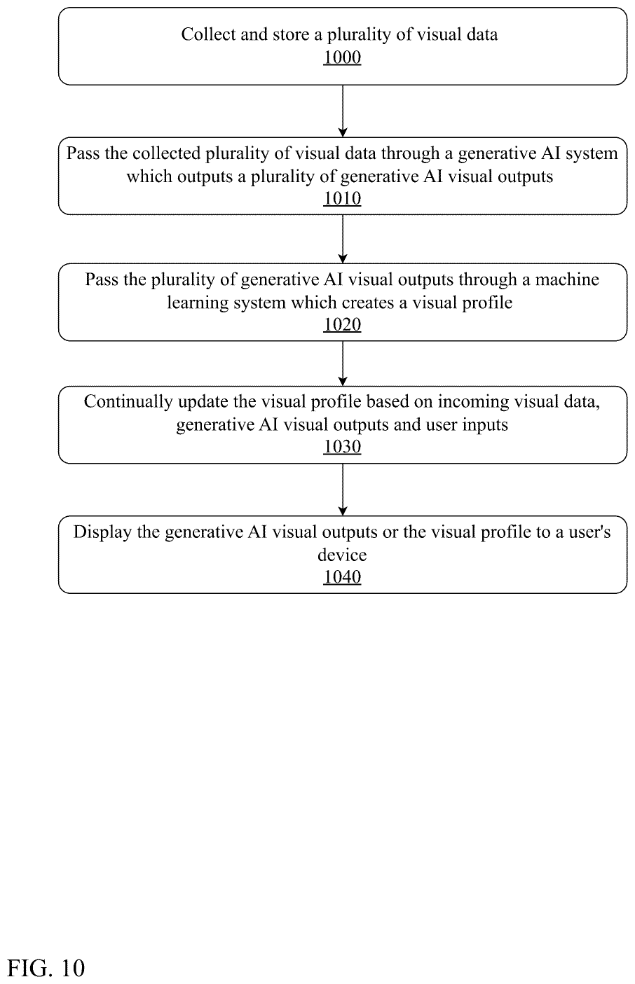

FIG. 10 is a flow diagram illustrating an exemplary method for generating visuals and displaying visuals to a user's device. In a first step 1000, collect and store a plurality of visual data. Visual data may come from a plurality of sources which may include but are not limited to video footage and images. In step 1010, pass the collected plurality of visual data through a generative AI system which outputs a plurality of generative AI visual outputs. The generative AI system may take in a plurality of visual data which it may use to generate new visual environments and elements. For example, if the simulated environment is a racetrack, the generative AI system may take in images and footage of a particular track which it would then use to generate a virtual recreation of that track. The virtual recreation may include the shape of the track, any surrounding buildings and foliage, where crowds stand, the appearance of the vehicles on the track, and any environmental effects like rain or snow. In step 1020, pass the plurality of generative AI visual outputs through a machine learning system which creates a visual profile. The visual profile may be used to generate a virtual environment, including any objects which a user would generally not be interacting with. In step 1030, continually update the visual profile based on incoming visual data, generative AI visual outputs, and user inputs. In one embodiment, the visual profile may be dynamic and ever changing depending on how the generated virtual environment is interacted with. For example, in a racing environment if a vehicle hits a wall at a high enough speed, the visual profile may need to update to display a crash. Likewise, if the user is operating a virtual vehicle and spins out the virtual profile will need to render everything behind the user and the effect of spinning around. The machine learning system and the generative AI system may take in all user inputs and update the visual profile and virtual environment to accurately reflect changes in the virtual world. In step 1040, display the generative AI visual outputs or the visual profile to a user's device. The visual output or visual profile may be displayed through a graphics processing unit. A user's device may include but is not limited to, a computer monitor, a television display, a mobile or handheld computing device display, or a projected image.

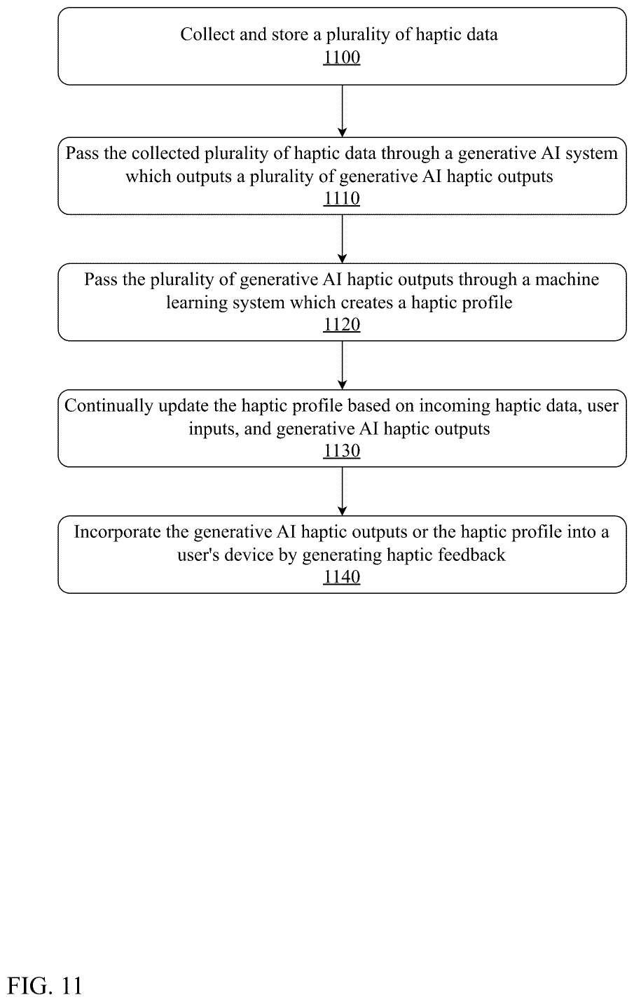

FIG. 11 is a flow diagram illustrating an exemplary method for generating haptic feedback and incorporating the feedback into a user's device. In a first step 1100, collect and store a plurality of haptic data. Haptic data may include but is not limited to vibrations, accelerations and decelerations, or increases or decreases both horizontal and vertical motion. In step 1110, pass the collected plurality of haptic data through a generative AI system which outputs a plurality of generative AI haptic outputs. The generative AI haptic outputs may be generated vibrations which may be experienced in a virtual environment. For example, based on the incoming haptic data, the generative AI system may generate a series of vibrations to simulate firmly stepping on the brakes in a vehicle. The motion of rapid decelerations may also be generated. In step 1120, pass the plurality of generative AI haptic outputs through a machine learning system which creates a haptic profile. The haptic profile includes the totality of all expected haptic feedback in a particular virtual environment based on a plurality of inputs. The haptic profile may be dynamic meaning it is continually updated based on what is happening in the virtual environment. In step 1130, continually update the haptic profile based on incoming haptic data, user inputs, and generative AI haptic outputs. For example, in a racing environment, if a user crashes a car into a wall, the haptic profile may be updated to reflect the change in the environment and generate a corresponding haptic feedback to reflect the crash. The haptic feedback may consist of a series of vibrations and actuator motion to replicate the sensations of crashing using a user's device. In step 1140, incorporate the generative AI haptic outputs or the haptic profile into a user's decide by generating haptic feedback. A user may use a plurality of devices capable of generating haptic feedback. Devices may include but are not limited to actuators built into a platform, controllers capable of generating vibrations, sound systems which can generate low frequencies to simulate vibrations, or other systems which profile multiple degrees of freedom of motion.

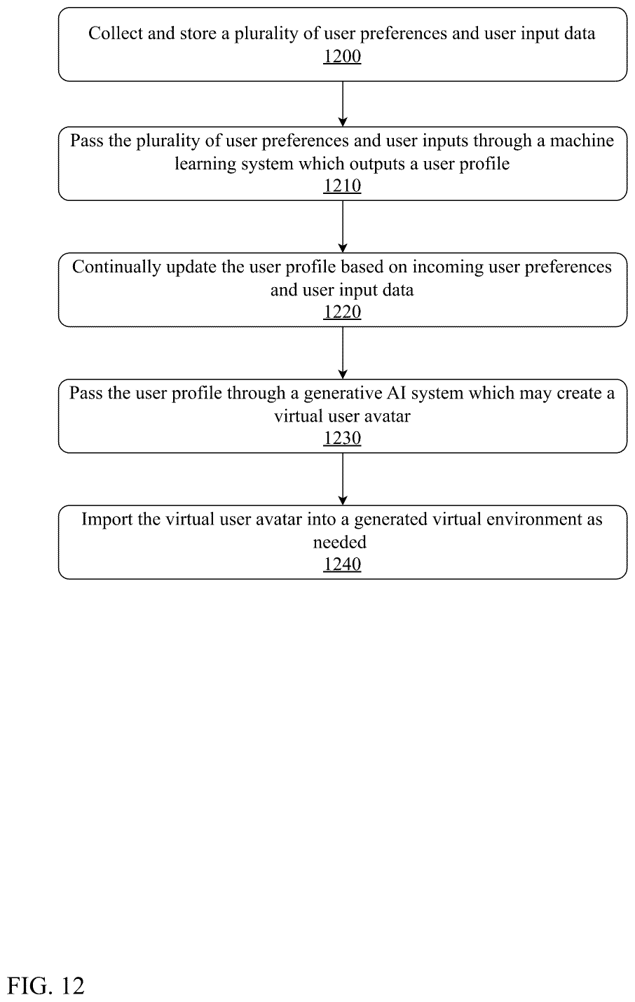

FIG. 12 is a flow diagram illustrating an exemplary method for creating a user simulation profile. In a first step 1200, collect and store a plurality of user preferences and user input data. In step 1210, pass the plurality of user preference and user inputs through a machine learning system which outputs a user profile. In step 1220, continually update the user profile based on incoming user preferences and user input data. This step ensures the user profile is as accurate as possible. Users may update preferences at any point during a game or simulation and changes in preferences need to be taken into account to ensure a generated virtual experience is tailored to what a user wants. Additionally, a user's inputs are a reflection of their habits, skill, and understanding of a particular game or simulation. By collecting and analyzing user inputs a simulated user avatar will have the ability to perform in the exact same manner as a user would in a particular circumstance. In step 1230, pass the user profile through a generative AI system which may create a virtual user avatar. In step 1240, import the virtual user avatar into a generated virtual environment as needed. The virtual user avatar has the ability to replicate a user's skill level at any point during their time in a game or simulation. A user may use this feature as a way of playing against past versions of themselves to better correct bad habits and to physically observe growth over time.

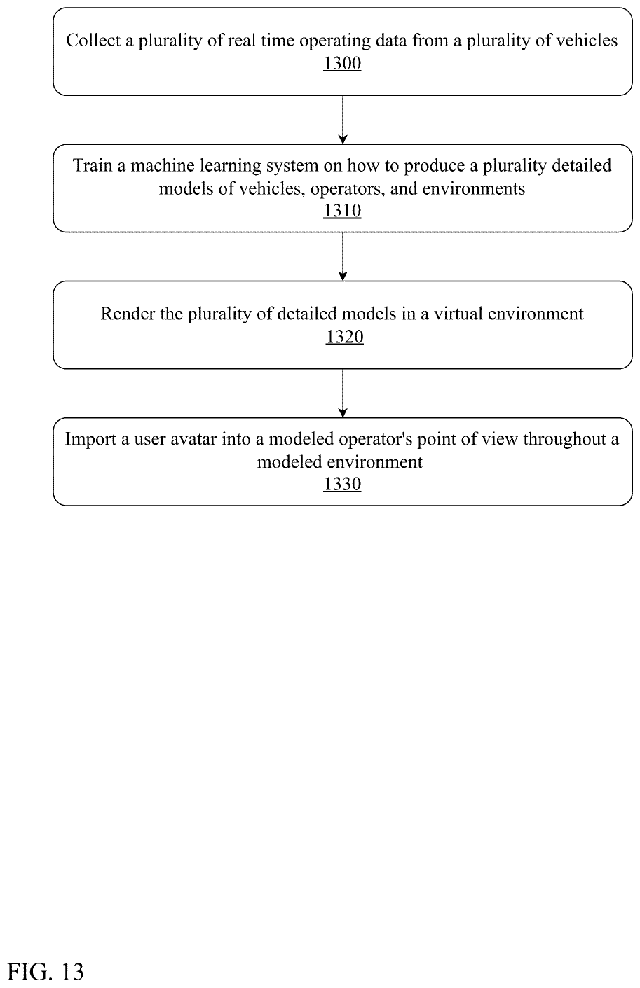

FIG. 13 is a flow diagram illustrating an exemplary method for a creating a possible game state; replay. In a first step 1300, collect a plurality of real time operating data from a plurality of vehicles. In a step 1310, train a machine learning system on how to produce a plurality of detailed models of vehicles, operators, and environments. In a step 1320, render the plurality of detailed models in a virtual environment. In a step 1330, import a user avatar into a modeled operator's point of view throughout a modeled environment. The user may observe everything that a modeled operator experiences while operating their corresponding modeled vehicle. For example, a user may sit in and experience everything that F1 driver Charles LeClerc experiences during a particular race. This can be done for any operator and any vehicle. Additionally, the user may select from any modeled environment.

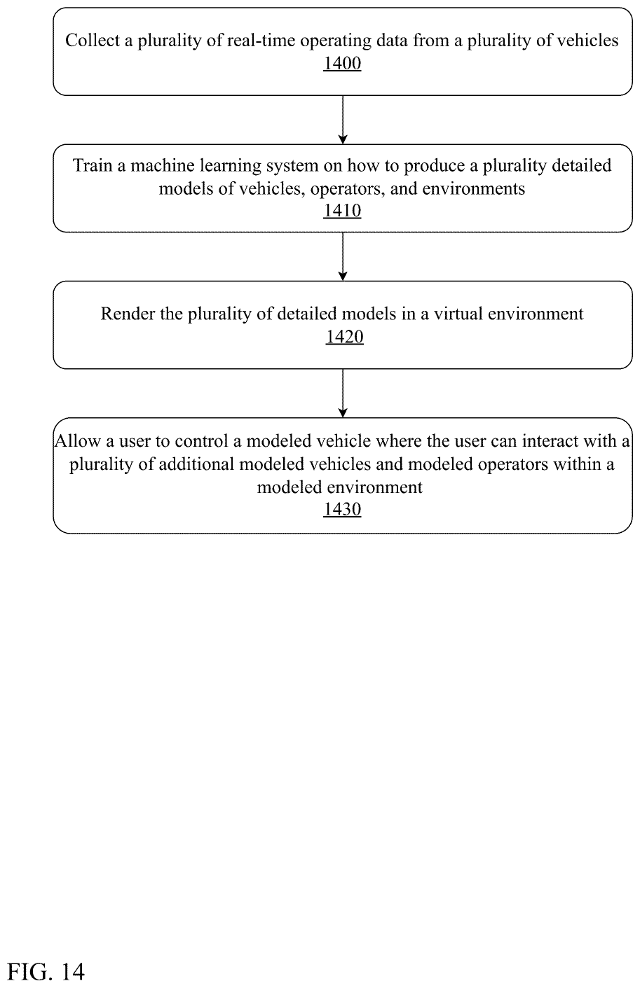

FIG. 14 is a flow diagram illustrating an exemplary method for a creating a possible game state; free play. In a first step 1400, collect a plurality of real time operating data from a plurality of vehicles. In a step 1410, train a machine learning system on how to produce a plurality of detailed models of vehicles, operators, and environments. In a step 1420, render the plurality of detailed models in a virtual environment. In a step 1430, allow a user to control a modeled vehicle where the user can interact with a plurality of additional modeled vehicles and modeled operators within a modeled environment. Rather than just observe what an operator experiences, this game state allows the user to directly influence a modeled vehicle and the modeled environment. In one embodiment, the user may want to directly compete in an F1 race using the Red Bull car. The user can take control of the modeled vehicle and race against any number of generated vehicles with corresponding operators. A user may additionally control if and when they want to take control of a modeled vehicle. For example, a user may elect to have a modeled operator of Charles LeClerc begin a race for them. The user may then take control and finish the race at any point. This option gives users free reign to spectate within a particular environment or directly engage with it at will.

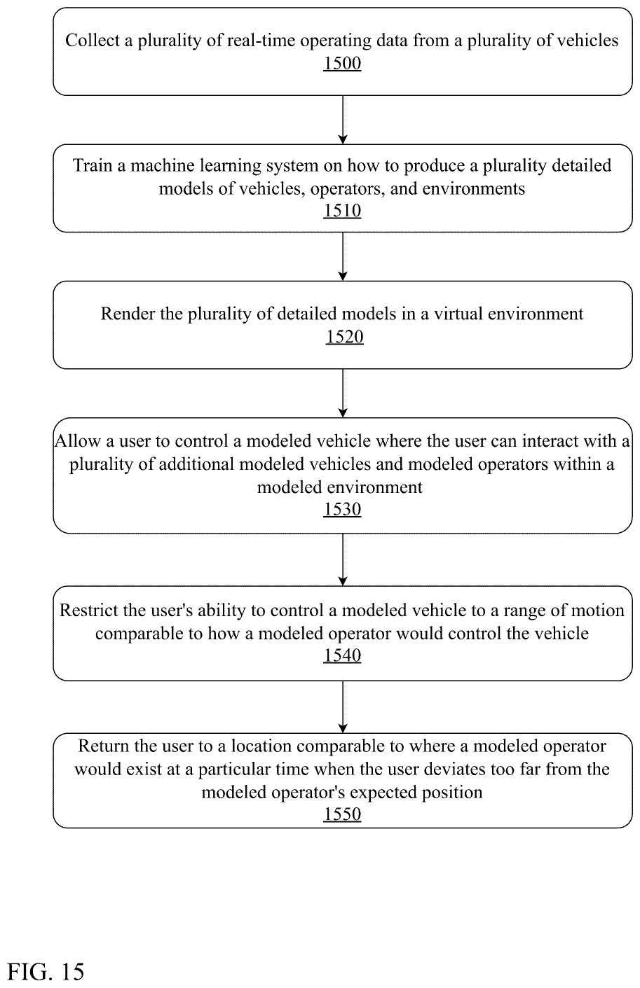

FIG. 15 is a flow diagram illustrating an exemplary method for a creating a possible game state; training wheels. In a first step 1500, collect a plurality of real time operating data from a plurality of vehicles. In a step 1510, train a machine learning system on how to produce a plurality of detailed models of vehicles, operators, and environments. In a step 1520, render the plurality of detailed models in a virtual environment. In a step 1530, allow a user to control a modeled vehicle where the user can interact with a plurality of additional modeled vehicles and modeled operators within a modeled environment. In a step 1540, restrict the user's ability to control a modeled vehicle to a range of motion comparable to how a modeled operator would control the vehicle. In a step 1550, return the user to a location comparable to where a modeled operator would exist at a particular time when the user deviates too far from the modeled operator's expected position. This game state allows the user to attempt to replicate how a particular operator controls their corresponding vehicle. A user may start controlling the modeled vehicle, but if their inputs cause the vehicle to stray too far from where the vehicle would be if the modeled operator were controlling the car, the user's position may be corrected back to where the operator would be in that particular moment. This process may also be performed when a user collides with other models within the environment, including but not limited to walls or other vehicles.

In some embodiments, if the user does not perform the same steps as an operator would in a particular situation from the start, models generated behind the scenes for the user may collide with the backside of the user's modeled vehicle. This may cause any actuators to stutter back and forth, especially if the user's modeled vehicle is continually being brought back to where the modeled vehicle would be if the operator were controlling it. This sensation of constantly being collided with may be smoothed out to reduce discomfort for a user by passing actuator data through the machine learning system 150. The machine learning system 150 may process actuator data and gradually return them to an optimal position to prevent the user from being thrust back and forth by constant collisions.

### Exemplary Computing Environment

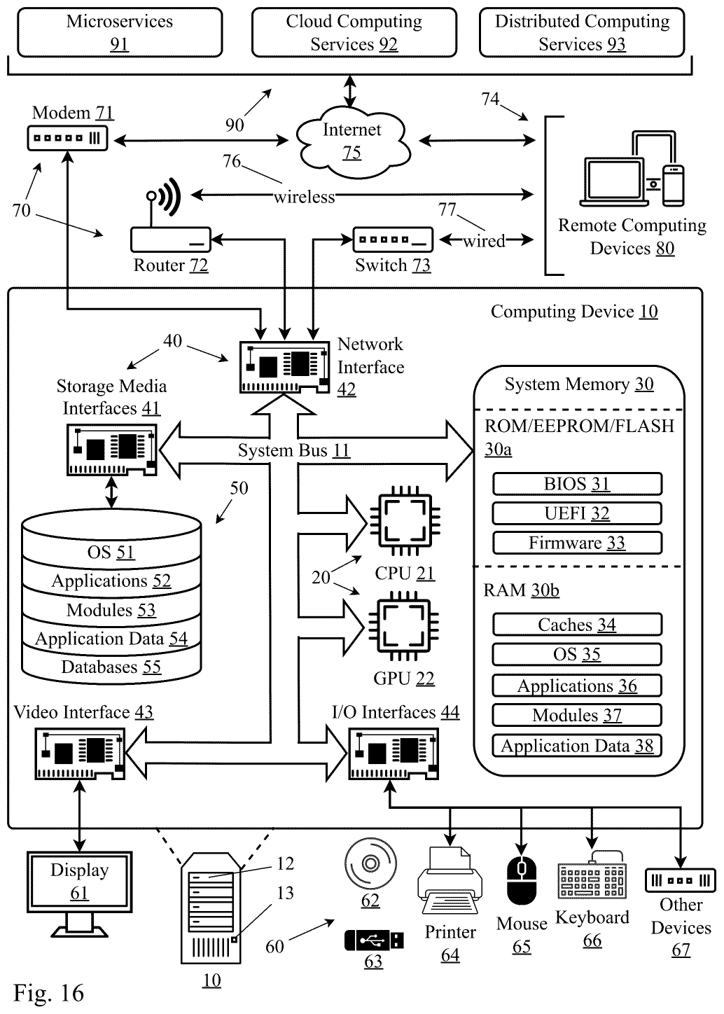

FIG. 16 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for AI-enabled telematics and actuation for electronic entertainment, simulation, training and remote operations systems, comprising:
a computing device comprising at least a memory and a processor;
a plurality of programming instructions stored in the memory and operable on the processor, wherein the first plurality of programming instructions, when operating on the processor, cause the computing device to:
collect a plurality of operating data from a plurality of vehicles, operators, and environments wherein operating data may include visual, acoustic, mechanical, and user control data;
train a machine learning system using the plurality of operating data on how to produce a plurality of models for vehicles, operators, and environments;
produce a plurality of models using the machine learning system and a plurality of generative AI systems;
display the plurality of models to a user's electronic video game or simulation system; and
generate a simulated user avatar using the plurality of generative AI systems which may enable a user to interact with the plurality of models.

2. The system of claim 1, wherein operating data further comprises the past and current positions of a plurality of operable actuators paired with the user's electronic video game or simulation system.

3. The system of claim 2, wherein the machine learning system is further trained using the past and current positions of the plurality of actuators, wherein the machine learning system may establish a preferred actuator position where actuators may gradually return after throughout a plurality of user inputs.

4. The system of claim 3, wherein the simulated user avatar may take the place of a selected modeled operator in a selected modeled vehicle while the selected modeled vehicle traverses through a selected modeled environment.

5. The system of claim 4, wherein a user may control the selected modeled vehicle and interact with the plurality of modeled vehicles, operators, and environments which the machine learning system or plurality of generative AI systems may update depending on the plurality of user inputs.

6. The system of claim 5, wherein the user's ability to control the selected modeled vehicle is restricted depending on the difference in a first position where the selected modeled operator is controlling the selected modeled vehicle and a second position where the plurality of user inputs is controlling the selected modeled vehicle.

7. The system of claim 1, wherein the plurality of models for vehicles, operators, and environments includes models for all objects, people, weather systems, terrains, animals, and vehicles which may or may not be present in a given environment.

8. A method for AI-enabled telematics and actuation for electronic entertainment, simulation, training and remote operations systems, comprising the steps of:
collecting a plurality of operating data from a plurality of vehicles, operators, and environments wherein operating data may include visual, acoustic, mechanical, and user control data;
training a machine learning system using the plurality of operating data on how to produce a plurality of models for vehicles, operators, and environments;
producing a plurality of models using the machine learning system and a plurality of generative AI systems;
displaying the plurality of models to a user's electronic video game or simulation system; and
generating a simulated user avatar using the plurality of generative AI systems which may enable a user to interact with the plurality of models.

9. The method of claim 8, wherein operating data further comprises the past and current positions of a plurality of actuators operable paired with the user's electronic video game or simulation system.

10. The method of claim 9, wherein the machine learning system is further trained using the past and current positions of the plurality of actuators, wherein the machine learning system may establish a preferred actuator position where actuators may gradually return after throughout a plurality of user inputs.

11. The method of claim 10, wherein the simulated user avatar may take the place of a selected modeled operator in a selected modeled vehicle while the selected modeled vehicle traverses through a selected modeled environment.

12. The method of claim 11, wherein a user may control the selected modeled vehicle and interact with the plurality of modeled vehicles, operators, and environments which the machine learning system or plurality of generative AI systems may update depending on the plurality of user inputs.

13. The method of claim 12, wherein the user's ability to control the selected modeled vehicle is restricted depending on the difference in a first position where the selected modeled operator is controlling the selected modeled vehicle and a second position where the plurality of user inputs is controlling the selected modeled vehicle.

14. The method of claim 8, wherein the plurality of models for vehicles, operators, and environments includes models for all objects, people, weather systems, terrains, animals, and vehicles which may or may not be present in a given environment.

15. Non-transitory, computer-readable storage media having computer-executable instructions embodied thereon that, when executed by one or more processors of a computing system employing an asset registry platform for AI-enabled telematics and actuation for electronic entertainment, simulation, training and remote operations systems, cause the computing system to:
collect a plurality of data from a plurality of data sources;
combine similar data into a plurality of classed data;
send a plurality of classed data through a generative AI system;
process the plurality of classed data into a plurality of generative AI outputs;
send the plurality of generative AI outputs, a plurality of game state data, and a plurality of user input data through a machine learning system;
predict an optimal future game state based on the plurality of generative AI outputs, the plurality of game state data, and the plurality of user input data;
generate a new game state based on the machine learning system's prediction; and
send the plurality of generative AI outputs or the new game state to the user device.

16. The media of claim 15, wherein operating data further comprises the past and current positions of a plurality of actuators operable paired with the user's electronic video game or simulation system.

17. The method of claim 16, wherein the machine learning system is further trained using the past and current positions of the plurality of actuators, wherein the machine learning system may establish a preferred actuator position where actuators may gradually return after throughout a plurality of user inputs.

18. The method of claim 17, wherein the simulated user avatar may take the place of a selected modeled operator in a selected modeled vehicle while the selected modeled vehicle traverses through a selected modeled environment.

19. The method of claim 18, wherein a user may control the selected modeled vehicle and interact with the plurality of modeled vehicles, operators, and environments which the machine learning system or plurality of generative AI systems may update depending on the plurality of user inputs.

20. The method of claim 19, wherein the user's ability to control the selected modeled vehicle is restricted depending on the difference in a first position where the selected modeled operator is controlling the selected modeled vehicle and a second position where the plurality of user inputs is controlling the selected modeled vehicle.

21. The method of claim 15 wherein the plurality of models for vehicles, operators, and environments includes models for all objects, people, weather systems, terrains, animals, and vehicles which may or may not be present in a given environment.

22. A system for AI-enabled telematics and actuation for electronic entertainment, simulation, training and remote operations systems, comprising one or more computers with executable instructions that, when executed, cause the system to:
collect a plurality of data from a plurality of data sources;
combine similar data into a plurality of classed data;
send a plurality of classed data through a generative AI system;
process the plurality of classed data into a plurality of generative AI outputs;
send the plurality of generative AI outputs, a plurality of game state data, and a plurality of user input data through a machine learning system;
predict an optimal future game state based on the plurality of generative AI outputs, the plurality of game state data, and the plurality of user input data;
generate a new game state based on the machine learning system's prediction; and
send the plurality of generative AI outputs or the new game state to the user device.

23. The system of claim 22, wherein operating data further comprises the past and current positions of a plurality of operable actuators paired with the user's electronic video game or simulation system.

24. The system of claim 23, wherein the machine learning system is further trained using the past and current positions of the plurality of actuators, wherein the machine learning system may establish a preferred actuator position where actuators may gradually return after throughout a plurality of user inputs.

25. The system of claim 24, wherein the simulated user avatar may take the place of a selected modeled operator in a selected modeled vehicle while the selected modeled vehicle traverses through a selected modeled environment.

26. The system of claim 25, wherein a user may control the selected modeled vehicle and interact with the plurality of modeled vehicles, operators, and environments which the machine learning system or plurality of generative AI systems may update depending on the plurality of user inputs.

27. The system of claim 26, wherein the user's ability to control the selected modeled vehicle is restricted depending on the difference in a first position where the selected modeled operator is controlling the selected modeled vehicle and a second position where the plurality of user inputs is controlling the selected modeled vehicle.

28. The system of claim 22, wherein the plurality of models for vehicles, operators, and environments includes models for all objects, people, weather systems, terrains, animals, and vehicles which may or may not be present in a given environment.
